(19) United States
(12) Patent Application Publication
(10) Pub. No.: US 2025/0310709 A1
(43) Pub. Date: Oct. 2, 2025

(54) TECHNIQUES FOR AUDIO COMPENSATION FOR A BLUETOOTH HEADSET

(71) Applicant: HARMAN INTERNATIONAL INDUSTRIES, INCORPORATED, Stamford, CT (US)

(72) Inventors: Hesheng BAO, Shenzhen (CN); Yongbo DENG, Shenzhen (CN)

(21) Appl. No.: 19/082,616

(22) Filed: Mar. 18, 2025

(30) Foreign Application Priority Data
Mar. 26, 2024 (CN) CN202410349355.5

(51) Int. Cl. H04R 25/00; H04R 3/04

(52) U.S. Cl. CPC H04R 25/70; H04R 3/04; H04R 2420/07; H04R 2430/01

(57) ABSTRACT

Disclosed are an audio compensation method and device for a Bluetooth headset, a Bluetooth headset, and a computer-readable storage medium, wherein the Bluetooth headset comprises a pair of earphone components corresponding to both ears of a user respectively, and the method comprises: acquiring a monaural hearing loss curve corresponding to each ear of the user; wherein the monaural hearing loss curve corresponding to each ear of the user is generated based on a monaural hearing loss test of the corresponding ear of the user; acquiring an original audio signal of the Bluetooth headset at the first time; compensating the original audio signal of the Bluetooth headset at the first time based on the monaural hearing loss curve corresponding to each ear of the user to generate a compensated audio signal.

### CROSS-REFERENCE TO RELATED APPLICATIONS

This application claims priority benefit of Application No. CN 202410349355.5 titled, “AUDIO COMPENSATION METHOD FOR BLUETOOTH HEADSET, BLUETOOTH HEADSET AND COMPUTER-READABLE STORAGE MEDIUM,” filed on Mar. 26, 2024. The subject matter of this related application is hereby incorporated herein by reference.

### BACKGROUND

### Field of the Various Embodiments

The present disclosure relates to the field of audio processing, and more specifically to an audio compensation method for a Bluetooth headset, a Bluetooth headset and a computer-readable storage medium.

As audio processing is widely applied in the civil and commercial sectors, audio processing, especially audio processing for Bluetooth headsets, is facing higher requirements.

Currently in the audio processing for Bluetooth headsets, when a user makes calls via a Bluetooth headset, he/she finds that the downlink voice performance is not very clear and the user feels that the sound is a bit muffled. Especially during prolonged online conference calls (which usually take 1 or 2 hours), the user listens to vague, unclear and dull voices in the Bluetooth headset for a long time, which will significantly affect the call experience of the user. Call survey results show that one of the reasons for the difference in call performance (the call voice heard by the user) lies in the different hearing losses for different persons. Some persons feel that the remote sound is muffled because he/she has partial hearing loss at certain frequency points. This hearing loss is not significant and will not affect their daily life, but it will affect their call experience during Bluetooth voice communication.

On this basis, there is a need for an audio compensation method for a Bluetooth headset that can achieve good audio broadcasting of the Bluetooth headset, especially good call audio broadcasting of the Bluetooth headset, while performing good personalized audio compensation based on the hearing losses of different persons, thereby improving the auditory experience of the user, especially allowing the user to have good call experience in personal calls.

### SUMMARY

In view of the above problems, the present disclosure provides an audio compensation method for a Bluetooth headset, a Bluetooth headset and a computer-readable storage medium. The audio compensation method provided by the present disclosure can achieve good audio broadcasting function of the Bluetooth headset, while performing good personalized audio compensation effectively based on the hearing losses of different persons, thereby improving the auditory experience of the user, especially allowing the user to have good call experience in personal calls.

According to a first aspect of the present disclosure, an audio compensation method for a Bluetooth headset is provided, where the Bluetooth headset comprises a pair of earphone components corresponding to both ears of a user respectively, and the method comprises: acquiring a monaural hearing loss curve corresponding to each ear of the user; where the monaural hearing loss curve corresponding to each ear of the user is generated based on a monaural hearing loss test of the corresponding ear of the user; acquiring an original audio signal of the Bluetooth headset at the first time; and compensating the original audio signal of the Bluetooth headset at the first time based on the monaural hearing loss curve corresponding to each ear of the user to generate a compensated audio signal.

In some embodiments, generating the monaural hearing loss curve of each ear of the user based on the monaural hearing loss test of the corresponding ear of the user comprises: for each ear of the user: detecting a hearing level of the ear at a plurality of preset frequency points to obtain a maximum inaudible volume of the ear at each preset frequency point; determining a hearing loss amount of the ear at each preset frequency point based on the maximum inaudible volume of the ear at each preset frequency point; and determining the monaural hearing loss curve based on the hearing loss amount of the ear at each preset frequency point.

In some embodiments, detecting a hearing level of the ear at a plurality of preset frequency points to obtain a maximum inaudible volume of the ear at each preset frequency point comprises: at each preset frequency point: playing a preset audio signal corresponding to the preset frequency point to the user through a corresponding earphone component, where a volume of the preset audio signal decreases from a preset maximum volume to a preset minimum volume according to a preset rule; obtaining hearing level feedback from the user, and determining the maximum inaudible volume of the ear at the preset frequency point based on the hearing level feedback.

In some embodiments, the volume of the preset audio signal decreases from the preset maximum volume to the preset minimum volume by a preset volume interval value.

In some embodiments, obtaining hearing level feedback from the user, and determining the maximum inaudible volume of the ear at the preset frequency point based on the hearing level feedback comprises: not recording a volume of the preset audio signal under the condition of obtaining a first hearing level feedback from the user; recording the current volume of the preset audio signal under the condition of obtaining a second hearing level feedback from the user, and determining the current volume as the maximum inaudible volume at the preset frequency point; where the first hearing level feedback is different from the second hearing level feedback.

In some embodiments, the hearing level feedback is gesture feedback, and the Bluetooth headset further comprises a human-computer interaction part, where obtaining hearing level feedback from the user comprises obtaining the gesture feedback from the user via the human-computer interaction part.

In some embodiments, determining a hearing loss amount of the ear at each preset frequency point based on the maximum inaudible volume of the ear at each preset frequency point comprises determining the maximum inaudible volume at the preset frequency point as the hearing loss amount at the preset frequency point.

In some embodiments, based on the monaural hearing loss curve corresponding to each ear of the user, compensating the original audio signal of the Bluetooth headset at the first time to generate a compensated audio signal includes: for each earphone component of the Bluetooth headset: determining the monaural hearing loss curve of the user corresponding to the earphone component; obtaining the original audio signal of the earphone component at the first time and a preset threshold volume corresponding to the earphone component; and compensating the original audio signal based on the monaural hearing loss curve and the preset threshold volume to generate a compensated audio signal.

In some embodiments, compensating the original audio signal based on the monaural hearing loss curve and the preset threshold volume to generate a compensated audio signal comprises: determining a frequency point corresponding to the original audio signal, and determining a hearing loss amount corresponding to the frequency point on the monaural hearing loss curve; determining an audio compensation parameter based on the hearing loss amount, the volume of the original audio signal and the preset threshold volume; and performing audio compensation processing on the original audio signal based on the audio compensation parameter to generate a compensated audio signal; where a volume of the compensated audio signal is less than the preset threshold volume.

In some embodiments, the original audio signal at the first time is the original call audio signal at the first time.

In some embodiments, before detecting a hearing level of the ear at a plurality of preset frequency points to obtain a maximum inaudible volume of the ear at each preset frequency point, the method further comprises performing a hearing loss test preprocessing operation.

In some embodiments, the hearing loss test preprocessing operation comprises receiving personal information of users; determining the preset frequency point in the hearing loss test based on the personal information; where the personal information comprises at least one of user's age, user's gender or user's hearing level information.

In some embodiments, the hearing loss test preprocessing operation comprises at least one of noise detection or wearing detection.

According to another aspect of the present disclosure, a Bluetooth headset is provided, comprising a pair of earphone components corresponding to both ears of a user respectively, where each earphone component comprises a processor and a memory, for each earphone component: the memory is configured to store a monaural hearing loss curve of the user's corresponding ear corresponding to the earphone component, where the monaural hearing loss curve of the user's corresponding ear is generated based on a monaural hearing loss test of the corresponding ear of the user; and the processor is configured to acquire the monaural hearing loss curve from the processor; acquire an original audio signal of the earphone component at the first time; and compensate the original audio signal at the first time based on the monaural hearing loss curve to generate a compensated audio signal.

According to another aspect of the present disclosure, a computer-readable storage medium is provided, characterized in that computer-readable instructions are stored thereon, and when the instructions are executed by a computer, the method described above is performed.

### BRIEF DESCRIPTION OF THE DRAWINGS

In order to more clearly illustrate the technical solutions of the embodiments of the present disclosure, the accompanying drawings to be used in the description of the embodiments will be briefly introduced below, and it will be obvious that the accompanying drawings in the following description are only some of the embodiments of the present disclosure, and that for those of ordinary skill in the art, other accompanying drawings can be obtained based on these drawings without making creative labor. The following accompanying drawings are not intentionally drawn in scale to the actual dimensions, with the emphasis on illustrating the gist of the present disclosure.

FIG. 1 illustrates an exemplary flowchart of an audio compensation method for a Bluetooth headset according to some embodiments of the present disclosure;

FIG. 2 illustrates an exemplary flowchart of a process of generating a monaural hearing loss curve of each ear of the user according to some embodiments of the present disclosure;

FIG. 3 illustrates an exemplary flowchart of a process of obtaining a maximum inaudible volume of the ear at each preset frequency point according to some embodiments of the present disclosure;

FIG. 4 illustrates an exemplary flowchart of a process of generating a compensated audio signal according to some embodiments of the present disclosure; and

FIG. 5 illustrates a schematic diagram of a Bluetooth headset according to some embodiments of the present disclosure.

### DETAILED DESCRIPTION

The technical solutions in embodiments of the present disclosure will be clearly and completely described below in conjunction with the accompanying drawings, and it will be apparent that the embodiments described are only some embodiments of the present disclosure and not all of them. Based on the embodiments of the present disclosure, all other embodiments obtained by those of ordinary skill in the art without making creative labor fall within the scope of protection of the present disclosure.

As illustrated in the present application and the claims, unless clearly indicated in the context as an exception, the words “one,” “a,” “a kind of,” and/or “the” and the like do not refer specifically to the singular but can also include the plural. In general, the terms “including” and “comprising” indicate only the inclusion of clearly identified steps and elements, which do not constitute an exclusive list, and the method or the device can also contain other steps or elements.

Although the present application makes various references to certain modules in the system according to the embodiments of the present application, any number of different modules can be used and run on the user terminal and/or server. The modules described are merely illustrative, and different aspects of the systems and methods can use different modules.

Flowcharts are used in the present application to illustrate operations performed by a system according to an embodiment of the present application. It should be understood that the preceding or following operations are not necessarily performed in a precise sequence. Instead, various steps can be processed in a reverse order or simultaneously, as required. Meanwhile, it is also possible to add other operations to these processes or to remove one or more operations from these processes.

According to an aspect of the present disclosure, an audio compensation method 100 for a Bluetooth headset is proposed.

First, the Bluetooth headset is further described. The Bluetooth headset, for example, includes a pair of earphone components corresponding to both ears of a user respectively.

It should be understood that the Bluetooth headset can be, for example, a split-type Bluetooth headset, in which two earphone components are provided independently and separately of each other, and each earphone component can be charged separately in the Bluetooth battery compartment, for example. Alternatively, the Bluetooth headset can be a head-mounted Bluetooth headset, with two earphone components connected via a headband. It should be understood that embodiments of the present disclosure are not limited by the specific composition mode and type of the Bluetooth headset.

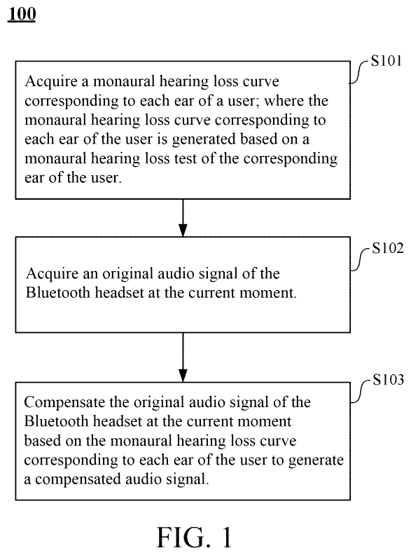

FIG. 1 illustrates an exemplary flowchart of an audio compensation method 100 for a Bluetooth headset according to some embodiments of the present disclosure.

Referring to FIG. 1, the method comprises, in Step S101, acquiring a monaural hearing loss curve corresponding to each ear of a user; where the monaural hearing loss curve corresponding to each ear of the user is generated based on a monaural hearing loss test of the corresponding ear of the user.

It should be understood that the monaural hearing loss curve corresponding to each ear of the user refers to the monaural hearing loss curve corresponding to the left ear and the right ear of the user (e.g., corresponding to different earphone components of the Bluetooth headset). The monaural hearing loss curve refers to a curve that characterizes the degree of hearing loss of the single ear (e.g., the left ear or the right ear) when performing a listening activity, which can, for example, include hearing loss amount data for the user at a plurality of preset frequency points. However, it should be understood that the embodiments of the present disclosure are not limited thereto.

It should be understood that the monaural hearing loss curve can, for example, be pre-generated and pre-stored in the memory of the Bluetooth headset or generated by performing a monaural hearing loss test on the user in real time before audio broadcasting (e.g., a Bluetooth call). It should be understood that the embodiments of the present disclosure are not limited thereto.

For example, the aforementioned process of acquiring the monaural hearing loss curve corresponding to each ear of the user can be more specifically described as for each earphone component, acquiring the monaural hearing loss curve of the corresponding ear of the user corresponding to the earphone component.

It should be understood that the monaural hearing loss test refers to testing the hearing loss degree for each ear of the user separately to obtain the monaural hearing loss curve.

The process of monaural hearing loss test can be, for example: for each ear of the user: detecting a hearing level of the ear at a plurality of preset frequency points to obtain a maximum inaudible volume of the ear at each preset frequency point; determining a hearing loss amount of the ear at each preset frequency point based on the maximum inaudible volume of the ear at each preset frequency point; and determining the monaural hearing loss curve based on the hearing loss amount of the ear at each preset frequency point.

However, it should be understood that only an exemplary process is given above, and the embodiments of the present disclosure are not limited thereto.

In step S102, an original audio signal of the Bluetooth headset at the first time is acquired.

It should be understood that the original audio signal of the Bluetooth headset at the first time refers to the original audio signal that the Bluetooth headset is intended to transmit to the client at the first time. Specifically, in a Bluetooth call scenario, the audio signal can be, for example, an original call signal; and in an audio playback scenario, the audio signal can be, for example, an original audio signal. It should be understood that the embodiments of the present disclosure are not limited by the specific signal type of the original audio signal.

For example, acquiring the original audio signal of the Bluetooth headset at the first time can, for example, be acquiring the original audio signals that the two earphone components of the Bluetooth headset are intended to transmit respectively at the first time, that is, acquiring the original audio signal of each of the two earphone components at the first time; or if only a single earphone component is currently used, for example, acquiring the original audio signal that the single earphone component is intended to transmit at the first time.

The original audio signal, to be distinguished from the compensated audio signal hereinafter, refers to an audio signal that has not undergone the audio compensation process in the present application. It should be understood that the embodiments of the present disclosure are not limited by the signal type and signal content of the original audio signal.

It should be understood that the aforementioned steps S101 and S102 can be performed in sequence, in reverse sequence, or simultaneously. The embodiments of the present disclosure are not limited by the specific sequence in which the steps S101 and S102 are performed.

In step S103, the original audio signal of the Bluetooth headset at the first time is compensated based on the monaural hearing loss curve corresponding to each ear of the user to generate a compensated audio signal.

The compensation processing refers to a process of compensating (e.g., compensating the volume value of the audio signal) and/or adjusting (e.g., decreasing the volume of the audio signal that obviously exceeds the maximum volume range) the original audio signal.

The compensation processing includes, for example: for each earphone component of the Bluetooth headset, compensating the original audio signal of the earphone component at the first time based on the monaural hearing loss curve to generate a compensated audio signal.

It should be understood that an exemplary process of audio compensation is given above, and the embodiments of the present disclosure are not limited thereto.

On this basis, in the present application, in an audio compensation method for a Bluetooth headset, an original audio signal of the Bluetooth headset at the first time is obtained; a monaural hearing loss curve corresponding to each ear of the user is obtained; the original audio signal of the Bluetooth headset at the first time is compensated based on the monaural hearing loss curve corresponding to each ear of the user to generate a compensated audio signal; and the monaural hearing loss curve corresponding to each ear of the user is generated based on a monaural hearing loss test of the ear of the user. Through such arrangements, the audio signal can be well personalized in audio according to the monaural hearing loss curve based on the hearing losses of different persons through the audio compensation method for the Bluetooth headset in a simple and convenient way, thereby improving the auditory experience of the user, especially allowing the user to have good call experience in personal calls.

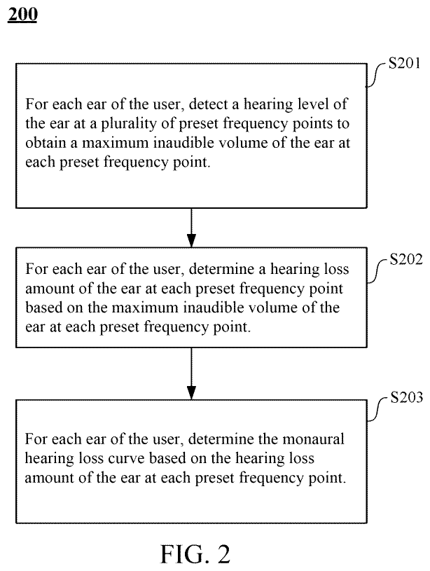

In some embodiments, the process of generating a monaural hearing loss curve of each ear of a user based on performing a monaural hearing loss test on the corresponding ear of the user can be described in more detail. FIG. 2 illustrates an exemplary flowchart of a process 200 of generating a monaural hearing loss curve of each ear of the user according to some embodiments of the present disclosure.

Referring to FIG. 2, in the process of generating a monaural hearing loss curve, first, in step S201, for each ear of the user, a hearing level of the ear at a plurality of preset frequency points is detected to obtain a maximum inaudible volume of the ear at each preset frequency point.

The preset frequency points refer to a plurality of preset frequency points, and the preset frequency points can be, for example, 250 Hz, 500 Hz, or 5000 Hz, 8000 Hz, etc. It should be understood that the embodiments of the present disclosure are not limited by the specific frequency value of the preset frequency point.

There can be, for example, three or eight preset frequency points. The preset frequency points can be, for example, consecutive frequency points, or can be equally spaced frequency points or unequally spaced frequency points, as appropriate. It should be understood that the embodiments of the present disclosure are not limited by the number of the preset frequency points and the distribution pattern of the preset frequency points.

The maximum inaudible volume at each preset frequency point refers to the lower limit volume when the user listens to an audio signal at the frequency point, that is, the user can hear the audio signal only when the volume of the audio signal is greater than the maximum inaudible volume, and when the volume of the audio signal is equal to or lower than the maximum inaudible volume, the user will not be able to hear the audio signal.

Detecting the hearing level of the ear at the plurality of preset frequency points can be done, for example, by playing a preset audio signal at the preset frequency points to the ear (e.g., the volume of the audio signal changes from high to low), and obtaining hearing level feedback of the user (e.g., different inputs or different gestures of the user, etc.) to determine the hearing level of the user. The hearing level here is characterized by the maximum inaudible volume of the user at the preset frequency points. It should be understood that the lower the maximum inaudible volume at a preset frequency point, the higher the hearing level of the user at the frequency point.

For example, the process of detecting a hearing level of the ear at a plurality of preset frequency points to obtain a maximum inaudible volume of the ear at each preset frequency point can comprise: at each preset frequency point: playing a preset audio signal corresponding to the preset frequency point to the user through a corresponding earphone component, where the volume of the preset audio signal decreases from a preset maximum volume to a preset minimum volume according to a preset rule; obtaining hearing level feedback from the user, and determining the maximum inaudible volume of the ear at the preset frequency point based on the hearing level feedback.

However, it should be understood that only an exemplary process of obtaining the maximum inaudible volume at a preset frequency point is given above. The embodiments of the present disclosure are not limited thereto.

Thereafter, in step S202, a hearing loss amount of the ear at each preset frequency point is determined based on the maximum inaudible volume of the ear at each preset frequency point.

It should be understood that the hearing loss amount refers to the hearing loss amount of the ear of the user at the preset frequency point, which is, for example, characterized as the volume loss (in decibel). For example, the hearing loss amount can characterize the volume range in which the user cannot hear the sound normally in the process in which the preset audio signal at the frequency point decreases from a preset maximum volume to a preset minimum volume. The hearing loss amount can be determined, for example, based on the maximum inaudible volume.

For example, if a preset audio signal corresponding to each preset frequency point is played to the user through the corresponding earphone component at the preset frequency point, with the volume of the preset audio signal decreased from a preset maximum volume to a preset minimum volume according to a preset rule, then the hearing loss amount at the preset frequency point can be determined based on the preset minimum volume of the preset audio signal at the preset frequency point and the maximum inaudible volume at the preset frequency point (e.g., by subtracting the preset minimum volume from the maximum inaudible volume).

However, it should be understood that only one exemplary method for determining the hearing loss amount is given above, and the embodiments of the present disclosure are not limited thereto.

Thereafter, after the hearing loss amount is determined, in step S203, the monaural hearing loss curve is determined based on the hearing loss amount of the ear at each preset frequency point.

For example, a graph can be drawn according to each preset frequency point and the hearing loss amount associated with the preset frequency point, where the horizontal axis represents the individual preset frequency points and the vertical axis represents the hearing loss amounts corresponding to the preset frequency points, thereby obtaining a monaural hearing loss curve.

On this basis, in the present disclosure, in the process of generating the monaural hearing loss curve of each ear of the user, for each ear of the user: a hearing level of the ear at a plurality of preset frequency points is detected to obtain a maximum inaudible volume of the ear at each preset frequency point; a hearing loss amount of the ear at each preset frequency point is determined based on the maximum inaudible volume of the ear at each preset frequency point; and the monaural hearing loss curve is determined based on the hearing loss amount of the ear at each preset frequency point. Through such arrangements, in the process of generating the monaural hearing loss curve, the maximum inaudible volume of each ear of the user at the individual preset frequency points can be tested separately, and the hearing loss amount can be determined based on the maximum inaudible volume at the plurality of preset frequency points, so that the obtained monaural hearing loss curve can well characterize the hearing level of the user's monaural ear at different frequency points, which facilitates the subsequent corresponding compensation of the original audio signal based on the monaural hearing loss curve, thereby improving the auditory experience of the user.

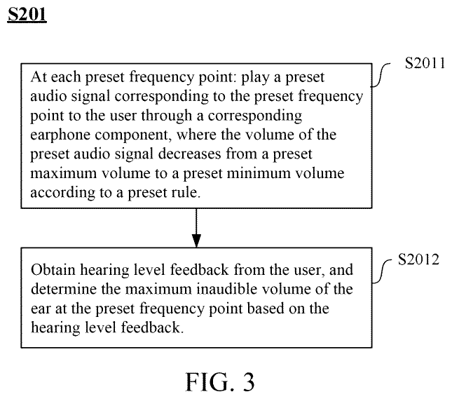

In some embodiments, the aforementioned step S201 of detecting the hearing level of the ear at a plurality of preset frequency points to obtain the maximum inaudible volume of the ear at each preset frequency point can be described in more detail. FIG. 3 illustrates an exemplary flowchart of a process S201 of obtaining a maximum inaudible volume of the ear at each preset frequency point according to some embodiments of the present disclosure.

Referring to FIG. 3, in Step S2011, at each preset frequency point, a preset audio signal corresponding to the preset frequency point is played to the user through a corresponding earphone component, where the volume of the preset audio signal decreases from a preset maximum volume to a preset minimum volume according to a preset rule.

The preset audio signal can be, for example, an audio signal having a frequency at a preset frequency point, and the embodiments of the present disclosure are not limited by the specific content and presentation manner of the audio signal.

The preset maximum volume refers to the maximum volume of the audio signal, and the preset minimum volume refers to the minimum volume of the audio signal. It should be understood that the maximum volume and the minimum volume can be set as appropriate, and different maximum and/or minimum volumes can be used for different frequency points, and the embodiments of the present disclosure are not limited thereto.

For example, depending on different application scenarios, when it is intended to compensate a call audio signal, for example, the preset maximum volume of each preset audio signal can be set to 40 dB and the preset minimum volume can be set to 1 dB, so that the test volume is more in line with the volume state in the call scenario. However, the embodiments of the present disclosure are not limited thereto.

Decrease of the volume of the preset audio signal from a preset maximum volume to a preset minimum volume according to a preset rule can, for example, be described more specifically. For example, the preset maximum volume of the preset audio signal is 90 decibels, the preset minimum volume is 0 decibels, and for example, the preset audio signal can be set to decrease from the maximum volume to the minimum volume at a preset volume interval value of 5 decibels, and for example, each volume lasts for 2 seconds. Then, at this time, the preset audio signal is first played at 90 decibels for 2 seconds, and then played at 85 decibels for 2 seconds, until it finally drops to 0 decibels.

However, it should be understood that only an example is given above of the volume of the preset audio signal decreasing from the preset maximum volume to the preset minimum volume according to a preset rule, and the embodiments of the present disclosure are not limited thereto.

Thereafter, in step S2012, hearing level feedback is obtained from the user, and the maximum inaudible volume of the ear at the preset frequency point is determined based on the hearing level feedback.

It should be understood that the hearing level feedback of the user refers to a feedback signal used to feedback the hearing level of the user at the current preset frequency point. It can be, for example, a gesture signal, or a voice signal, or an information signal input by the user, as appropriate. The embodiments of the present disclosure are not limited by the specific signal type of the feed signal of the hearing level feedback.

It should be understood that, for example, the maximum inaudible volume can be directly determined based on the hearing level feedback of the user, or the maximum inaudible volume can be obtained by processing based on a preset algorithm based on the hearing level feedback of the user. The embodiments of the present disclosure are not limited thereto.

For example, when the left ear of the user is tested, a preset audio signal corresponding to the preset frequency point can be played to the user via the earphone component corresponding to the left ear in the Bluetooth headset, and the user can provide feedback by, for example, continuously pressing the external touch surface of the earphone component. For example, in the process in which the volume of the preset audio signal decreases from a preset maximum volume to a preset minimum volume according to a preset rule, if the user continuously presses the external touch surface of the earphone component, it characterizes that the user can hear the amount of sound at the frequency point. When the hand of the user no longer touches the external touch surface of the earphone component, it characterizes that the user cannot hear the preset audio signal at this volume. However, it should be understood that the embodiments of the present disclosure are not limited thereto.

On this basis, in the present disclosure, when the maximum inaudible volume of the ear at each preset frequency point is obtained, at each preset frequency point: first a preset audio signal corresponding to the preset frequency point is played to the user through a corresponding earphone component, where a volume of the preset audio signal decreases from a preset maximum volume to a preset minimum volume according to a preset rule; then hearing level feedback is obtained from the user, and the maximum inaudible volume of the ear at the preset frequency point is determined based on the hearing level feedback. Through such arrangements, the embodiments of the present disclosure can accurately and reliably determine the maximum inaudible volume of the ear of the user at each preset frequency point in a simple and convenient manner, which facilitates the subsequent generation of a monaural hearing loss curve based on the maximum inaudible volume.

In some embodiments, the volume of the preset audio signal decreases from a preset maximum volume to a preset minimum volume at a preset volume interval value.

The preset volume interval value refers to the decibel value by which the volume decreases during a single volume decrease process. The preset volume interval value can be set to 3 dB, for example, to better meet the minimum audible hearing change for the human ear (the minimum change in sound pressure level that the human ear can perceive), or it can also be set to 4 dB, 6 dB, etc., as appropriate. It should be understood that the embodiments of the present disclosure are not limited by the specific data of the preset volume interval value.

For example, when the volume of the preset audio signal is set to decrease by 3 dB from a preset maximum volume of 100 dB to a preset minimum volume of 1 dB, and each volume is set to last for one second, the volume change of the preset audio is 100 dB, −97 dB, −94 dB, −91 dB, . . . −1 dB.

The volume of the preset audio signal decreases from a preset maximum volume to a preset minimum volume at a preset volume interval value. Through such arrangement, the step size of the volume decrease can be adjusted according to actual conditions, so that on the one hand, the amplitude of the volume decrease satisfies the minimum audible hearing change for the human ear, and the change of the audio volume can be perceived by the human body in a timely manner; on the other hand, the step size of the volume decrease can be set according to actual conditions to improve the accuracy of the maximum inaudible volume detected.

In some embodiments, the aforementioned process S2012 of obtaining hearing level feedback from the user and determining the maximum inaudible volume of the ear at the preset frequency point based on the hearing level feedback can be described in more detail.

For example, a current volume of the preset audio signal is not recorded under the condition of obtaining a first hearing level feedback from the user. The current volume of the preset audio signal is recorded under the condition of obtaining a second hearing level feedback from the user, and the current volume is determined as the maximum inaudible volume at the preset frequency point. The first hearing level feedback is different from the second hearing level feedback.

The first hearing level feedback and the second hearing level feedback refer to feedback signals for feeding back the hearing level of the user at the current preset frequency point. Specifically, the first hearing level feedback characterizes that the user has a good hearing level for the preset frequency signal at the current volume; and the second hearing level feedback characterizes that the user has a poor hearing level for the preset frequency signal at the current volume, that is, the user cannot hear the preset frequency signal at the current volume.

The first hearing level feedback and the second hearing level feedback can be, for example, a gesture signal, or a voice signal, or an information signal input by the user, as appropriate. The embodiments of the present disclosure are not limited by the specific feedback signal types of the first and second hearing level feedbacks.

It should be understood that the first hearing level feedback and the second hearing level feedback are only intended to distinguish between two different hearing level feedback conditions and are not intended to limit them.

The first and second hearing level feedbacks can be, for example, feedback signals of the same type, or feedback signals of different types, and the embodiments of the present disclosure are not limited thereto.

It should be understood that the expression of recording the current volume of the preset audio signal under the condition of obtaining a second hearing level feedback from the user and determining the current volume as the maximum inaudible volume at the preset frequency point means that when the second hearing level feedback is obtained, characterizing, for example, that the user cannot hear the preset frequency signal at the current volume at this time, the volume can, for example, be recorded at this time, and the volume is the maximum inaudible volume of the user at the frequency point.

On this basis, in the present disclosure, the current volume is not recorded under the condition of obtaining a first hearing level feedback from the user; the current volume is recorded under the condition of obtaining a second hearing level feedback from the user, and the current volume is determined as the maximum inaudible volume at the preset frequency point. Through such arrangements, corresponding processing can be performed flexibly based on different hearing level feedbacks, and the second hearing level feedback associated with poor hearing of the user can be accurately captured and the corresponding maximum inaudible volume can be obtained, thereby effectively and accurately determining the maximum inaudible volume at the frequency point.

In some embodiments, the hearing level feedback is gesture feedback, and the Bluetooth headset further comprises a human-computer interaction part, where obtaining hearing level feedback from the user comprises obtaining the gesture feedback from the user via the human-computer interaction part.

It should be understood that the gesture feedback refers to a feedback signal associated with the gesture of the user. For example, different gestures of the user can characterize different hearing level feedbacks.

It should be understood that the human-computer interaction part refers to a part for user interaction with users. The human-computer interaction part can be, for example, a mobile terminal (which interacts with the user and receives input from the user via a display screen) that communicates with the Bluetooth headset, or it can be a smart Bluetooth headset case for the Bluetooth headset. The Bluetooth headset case can, for example, accommodate an earphone component of the Bluetooth headset and charge the earphone component. The surface of the smart Bluetooth headset case can also have a display screen, and an input (such as a gesture) can be received from the user, for example, via the display screen.

However, it should be understood that only an exemplary human-computer interaction part is given above, and the embodiments of the present disclosure are not limited thereto.

It should be understood that the human-computer interaction part can be, for example, integrated with the Bluetooth headset (e.g., provided in the smart Bluetooth headset case of the Bluetooth headset), or the human-computer interaction part and the Bluetooth headset can be separately provided and communicate with each other in the usage scenario. For example, the human-computer interaction part can be the screen of the mobile terminal connected to the Bluetooth headset, which is reused as the human-computer interaction part of the Bluetooth headset after a connection is established with the Bluetooth headset. The embodiments of the present disclosure are not limited thereto.

For example, the human-computer interaction part can be a display screen on the Bluetooth headset case, which can, for example, display the monaural hearing loss test currently in progress, such as displaying the earphone component currently being tested (which corresponds to the corresponding monaural ear), and the frequency point being tested. It can be provided with a human-computer interaction area, in which the gestures of the user are collected. For example, the first hearing level feedback can be set as the user continuously touching the human-computer interaction area, and the second hearing level feedback can be set as the user stopping touching the human-computer interaction area (that is, the finger of the user moving away from the human-computer interaction area, for example, no longer touching the screen). At this time, for example, in the process of detecting the hearing level of the ear at a preset frequency point, while playing a preset audio signal corresponding to the preset frequency point through the earphone component (the volume of the preset audio signal decreases from a preset maximum volume to a preset minimum volume according to a preset rule), the user gestures in the human-computer interaction area can be collected through the display screen. When the user continuously touches the human-computer interaction area (e.g., the user keeps pressing the human-computer interaction area of the screen), it can, for example, be determined that the user has a good hearing level for the preset frequency signal at the current volume, and the current volume is not recorded at this time; and when the finger of the user leaves the screen and no longer touches the human-computer interaction area, it characterizes at this time that the user has a poor hearing level for the preset frequency signal at the current volume, that is, the preset frequency signal at the current volume cannot be heard. At this time, for example, the current volume can be recorded, and the current volume can be determined as the maximum inaudible volume at the preset frequency point.

On this basis, the Bluetooth headset includes a human-computer interaction part. Through such arrangement, in the process of performing a monaural hearing loss test, it is possible to reliably and accurately obtain gesture feedback from the user (which serves as the hearing level feedback) through the human-computer interaction part, and determine the current hearing level of the user through the gesture feedback, thereby effectively improving the human-computer interaction experience of the user during the test while accurately and reliably obtaining the hearing level of the user and determining the maximum inaudible volume.

In some embodiments, the determining a hearing loss amount of the ear at each preset frequency point based on the maximum inaudible volume of the ear at each preset frequency point in the aforementioned step S202 can be described in more detail, for example.

For example, the maximum inaudible volume at the preset frequency point can be directly determined as the hearing loss amount at the preset frequency point. For example, if the test shows that the maximum inaudible volume of the left ear of the user is 30 dB, then 30 dB can be directly determined as the hearing loss amount of the left ear of the user. Alternatively, the hearing loss amount can also be determined by further processing the maximum inaudible volume, for example, by processing it via a preset algorithm or function.

It should be understood that the embodiments of the present disclosure are not limited by the specific method for determining the hearing loss amount.

On this basis, by determining the hearing loss amount of the ear at each preset frequency point based on the maximum inaudible volume of the ear at each preset frequency point, the hearing loss amount of the user can be accurately and reliably determined based on the maximum inaudible volume, which facilitates subsequent corresponding compensation.

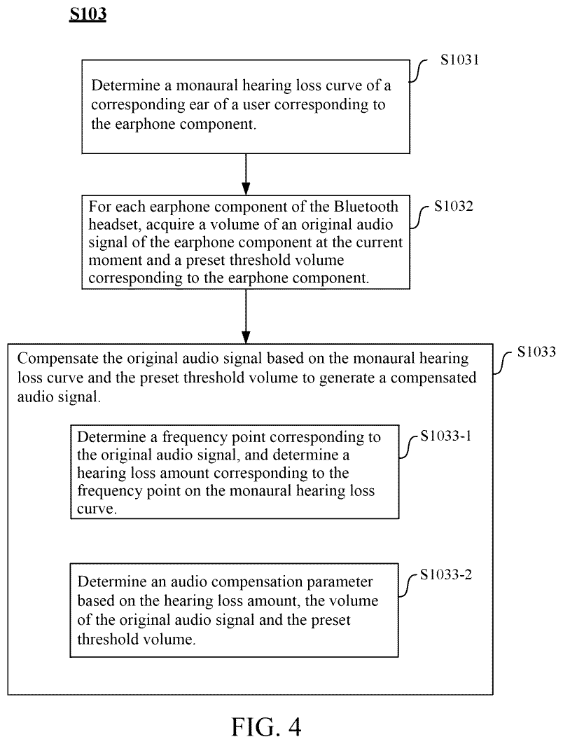

In some embodiments, the aforementioned process S103 of compensating the original audio signal of the Bluetooth headset at the first time based on the monaural hearing loss curve corresponding to each ear of the user to generate a compensated audio signal can, or example, be described in more detail. FIG. 4 illustrates an exemplary flowchart of a process S103 of generating a compensated audio signal according to some embodiments of the present disclosure.

Referring to FIG. 4, in step S1031, for each earphone component of the Bluetooth headset, a monaural hearing loss curve of a corresponding ear of the user corresponding to the earphone component is determined.

For example, the monaural hearing loss curve corresponding to an ear (e.g., the left ear or the right ear) of the user to which the earphone component corresponds can be determined based on the ear.

It should be understood that the monaural hearing loss curve can be stored in a memory built into the earphone component after being generated and can be retrieved from the memory of the earphone component when compensation is required.

In step S1032, for each earphone component of the Bluetooth headset, an original audio signal of the earphone component at the first time and a preset threshold volume corresponding to the earphone component are acquired.

The preset threshold volume corresponding to the earphone component refers to the maximum volume value of the audio signal set by the earphone component. The preset threshold volume can be preset by the Bluetooth headset or can be manually set by the user. The preset threshold volume is intended to define the upper limit of the audio volume within a normal range to prevent excessive volume from causing damage to the hearing of the user.

It should be understood that the aforementioned steps S1031 and S1032 can be performed in sequence, in reverse sequence, or concurrently. The embodiments of the present disclosure are not limited by the specific sequence in which the step S1031 and step S1032 are performed.

Thereafter, in step S1033, the original audio signal is compensated based on the monaural hearing loss curve and the preset threshold volume to generate a compensated audio signal.

The compensation processing refers to compensating the original audio signal (especially volume compensation) to make up well for the situation in which the user cannot hear the audio signal content below the maximum audible volume in each preset frequency point due to hearing loss.

For example, the aforementioned compensation process can include: determining an audio compensation parameter based on the monaural hearing loss curve, the volume of the original audio signal and the preset threshold volume; and performing audio compensation processing on the original audio signal based on the audio compensation parameter to generate a compensated audio signal; where a volume of the compensated audio signal is less than the preset threshold volume. However, it should be understood that the embodiments of the present disclosure are not limited thereto.

On this basis, in the present application, when the original audio signal of the Bluetooth headset at the first time is compensated to generate a compensated audio signal, for each earphone component of the Bluetooth headset, the monaural hearing loss curve of the user corresponding to the earphone component is determined; the volume of the original audio signal of the earphone component at the first time and a preset threshold volume corresponding to the earphone component are obtained; and the original audio signal is compensated based on the monaural hearing loss curve and the preset threshold volume to generate a compensated audio signal. Through such arrangements, in the process of compensation, the monaural hearing loss curve of the current user and the upper limit (the preset threshold volume) of the audio volume in the normal range are comprehensively taken into account, so that the compensation parameter can be flexibly configured, so that on the one hand, good audio volume compensation of the original audio signal at the corresponding frequency point is realized through the loss curve, on the other hand, the upper limit of the audio volume is taken into account, so as to avoid the damage to the hearing of the user caused by excessive volume after compensation, thereby allowing both desirable audio signal compensation and user hearing protection.

In some embodiments, with continued reference to FIG. 4, step S1033 of compensating the original audio signal based on the monaural hearing loss curve and the preset threshold volume to generate a compensated audio signal can be, for example, described in more detail.

Referring to FIG. 4, first, in step S1033-1, a frequency point corresponding to the original audio signal is determined, and a hearing loss amount corresponding to the frequency point is determined on the monaural hearing loss curve.

For example, based on detection of the frequency of the original audio signal, the frequency point corresponding to the original audio signal can be determined, and the hearing loss amount corresponding to the frequency point can be determined on the monaural hearing curve.

Thereafter, in step S1033-2, an audio compensation parameter is determined based on the hearing loss amount, the volume of the original audio signal and the preset threshold volume.

The volume of the original audio signal refers to the volume of the original audio signal that the earphone component is intended to transmit at the first time. For example, in a call scenario, it characterizes, for example, the volume of the original call audio signal transmitted by the headset at the first time.

It should be understood that the audio compensation parameter refers to a parameter used to compensate the original audio signal, which can be, for example, a key configuration parameter of an equalizer in an earphone component of the Bluetooth headset, such as a gain parameter corresponding to the frequency point. It should be understood that the embodiments of the present disclosure are not limited by the specific composition and type of the audio compensation parameter.

For example, the hearing loss amount, the volume of the original audio signal and the preset threshold volume can be processed based on a preset algorithm or a pre-trained neural network to determine the audio compensation parameter; or the correspondence between the combination of individual hearing loss amounts, the volume of the original audio signal and the preset threshold volume and the audio compensation parameter can be set in advance, and the expected corresponding audio compensation parameter can be determined based on the current hearing loss amount, the volume of the original audio signal and the preset threshold volume.

It should be understood that the embodiments of the present disclosure are not limited by the specific method for determining the audio compensation parameter.

Thereafter, in step S1033-3, audio compensation processing is performed on the original audio signal based on the audio compensation parameter to generate a compensated audio signal, where the volume of the compensated audio signal is less than the preset threshold volume.

It should be understood that, for example, the equalizer can be configured based on the audio compensation parameter, and compensation processing can be performed on the original audio signal via the equalizer to obtain a compensated audio signal.

It should be understood that in the present application, in the process of generating the compensated audio signal, first, a frequency point corresponding to the original audio signal is determined, and a hearing loss amount corresponding to the frequency point is determined on the monaural hearing loss curve; then an audio compensation parameter is determined based on the hearing loss amount, the volume of the original audio signal and the preset threshold volume; and audio compensation processing is performed on the original audio signal based on the audio compensation parameter to generate a compensated audio signal; and a volume of the compensated audio signal is made less than the preset threshold volume. Through such arrangements, the compensation of the original audio data can be achieved in a simple and convenient manner through the compensation method in the present application, and the generated compensated audio signal is made less than the upper limit of the audio volume, so as to avoid the damage to the hearing of the user caused by excessive volume after compensation, thereby allowing both desirable audio signal compensation and user hearing protection.

In some embodiments, the original audio signal at the first time is an original call audio signal at the first time.

For example, the application scenario of the Bluetooth headset is a call scenario, and the Bluetooth headset is correspondingly in a call mode (the Bluetooth headset transmits a call audio signal to the user at this time), and the original audio signal at this time is the original call audio signal at the first time (the call audio signal has not undergone audio compensation processing).

On this basis, by specially setting the audio compensation processing for the original call audio signal in the call scenario, good audio broadcasting of the Bluetooth headset, especially good call audio broadcasting of the Bluetooth headset, can be achieved, while performing good personalized audio compensation based on the hearing losses of different persons through the audio compensation method for a Bluetooth headset, thereby improving the auditory experience of the user, especially allowing the user to have good call experience in personal calls.

In some embodiments, before step S201 of, for each ear of the user, detecting a hearing level of the ear at a plurality of preset frequency points to obtain a maximum inaudible volume of the ear at each preset frequency point, the method further comprises performing a hearing loss test preprocessing operation.

It should be understood that the hearing loss test preprocessing operation refers to a preprocessing process before performing the monaural hearing loss test, which is intended to improve the reliability and accuracy of the hearing loss test. The preprocessing operation includes, for example, user information collection, noise detection, wearing detection, and the like. The embodiments of the present disclosure are not limited thereto.

On this basis, in the present application, a hearing loss preprocessing operation is performed before performing the hearing loss test. Through such arrangement, the reliability and accuracy of the hearing loss test and the obtained monaural hearing loss curve can be better improved.

In some embodiments, the hearing loss test preprocessing operation comprises receiving personal information of the user; where the personal information comprises at least one of user's age, user's gender or user's hearing level information.

It should be understood that, for example, the personal information of the user can be received via the aforementioned human-computer interaction interface. For example, the human-computer interaction interface can display a user information input window or options, and the user can fill in or select corresponding content according to his/her own situation.

The user hearing level information refers to the overall hearing level evaluation of the user, which can include, for example, options of excellent, good, and poor. However, it should be understood that only an example of the user hearing level information is given above, and the embodiments of the present disclosure are not limited thereto.

Thereafter, the preset frequency point in the hearing loss test is determined based on the personal information.

For example, a preset frequency point corresponding to the user can be determined in a candidate frequency point library based on the personal information. For example, the preset frequency point range and frequency point distribution for the user can be determined based on the personal information, so as to obtain the preset frequency point. Specifically, for example, for younger users with good hearing levels, 9 preset frequencies of 250 Hz, 500 Hz, 1000 Hz, 3000 Hz, 4000 Hz, 5000 Hz, 6000 Hz, 7000 Hz, and 8000 Hz can be selected; whereas for older users with poorer hearing levels, for example, on the basis of the aforementioned preset frequency points, high-frequency subdivided frequency points such as 6500 Hz, 7500 Hz, and 8500 Hz can be further added (considering that the hearing level for high-frequency points decreases with the increase of age). In addition, for example, for a male or female user, the preset frequency point can be determined according to the respective hearing loss susceptible frequency point range for male and hearing loss susceptible frequency point range for female.

On this basis, in the present application, the personal information of the user is received before performing a hearing loss test, and the preset frequency points in the hearing loss test are determined based on the personal information. Through such arrangements, the selection of preset frequency points can be personalized based on the personal characteristics of the user, thereby better adapting to the needs and situations of different users.

In some embodiments, the hearing loss test preprocessing operation includes at least one of noise detection or wearing detection.

The noise detection refers to detecting the noisy condition of the current Bluetooth headset accessories. For example, the surrounding environmental noise can be detected through the earphone components of the Bluetooth headset. When the volume of the surrounding environmental noise is less than a preset environmental noise threshold, it is determined that the noise detection passes; and when the volume of the surrounding environmental noise is greater than or equal to the preset environmental noise threshold, it is determined that the noise detection fails.

It should be understood that the preset environmental noise threshold can be, for example, 50 dB, or can be 40 dB, and the embodiments of the present disclosure are not limited by the specific numerical value of the preset environmental noise threshold.

The wearing detection refers to detecting whether the Bluetooth headset is worn properly by the user. The wearing detection can be performed, for example, by playing sample audio to the user through the earphone component, acquiring the audio via a microphone built into the headset to obtain an acquisition signal, and determining whether the headset is worn properly by the user based on the characteristics of the acquisition signal.

On this basis, noise detection can ensure that the external environment is in a less noisy condition when the hearing loss test is being performed, which facilitates reducing the interference from external environmental noise and improving detection accuracy; and wearing detection ensures that the Bluetooth headset is in a properly worn state when the hearing loss test is being performed, thereby avoiding incorrect hearing loss determination caused by improper wearing of the headset.

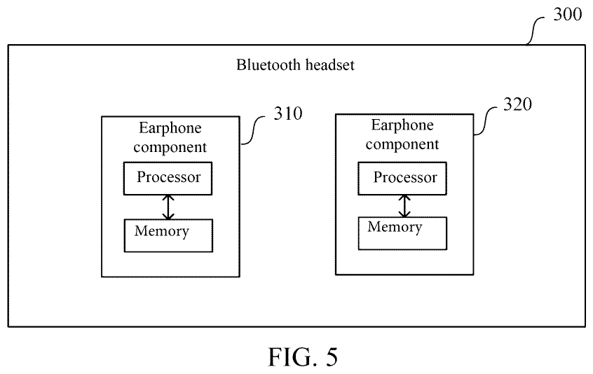

According to another aspect of the present disclosure, a Bluetooth headset is provided. FIG. 5 illustrates a schematic diagram of a Bluetooth headset 300 according to some embodiments of the present disclosure.

Referring to FIG. 5, the Bluetooth headset comprises a pair of earphone components 310 and 320 corresponding to both ears of a user respectively, where each earphone component comprises a processor and a memory.

Also, for each earphone component, the memory is configured to store a monaural hearing loss curve of a corresponding ear of the user corresponding to the earphone component, where the monaural hearing loss curve of the corresponding ear of the user is generated based on a monaural hearing loss test of the corresponding ear of the user.

It should be understood that the monaural hearing loss curve refers to a curve that characterizes the degree of hearing loss of a single ear (e.g., the left ear or the right ear) when performing a listening activity, which can, for example, include hearing loss amount data for the user at a plurality of preset frequency points. However, it should be understood that the embodiments of the present disclosure are not limited thereto.

It should be understood that the monaural hearing loss test refers to testing the degree of hearing loss of each ear of the user separately to obtain a monaural hearing loss curve.

The processor is configured to obtain the monaural hearing loss curve from the processor; obtain the original audio signal of the earphone component at the first time; and compensate the original audio signal at the first time based on the monaural hearing loss curve to generate a compensated audio signal.

It should be understood that the original audio signal of the earphone component at the first time refers to the original audio signal that the earphone component is intended to transmit to the client at the first time. Specifically, in a Bluetooth call scenario, the audio signal can be, for example, an original call signal; and in an audio playback scenario, the audio signal can be, for example, an original audio signal. It should be understood that the embodiments of the present disclosure are not limited by the specific signal type of the original audio signal.

The original audio signal, to be distinguished from the compensated audio signal, refers to an audio signal that has not undergone audio compensation process in the present application. It should be understood that the embodiments of the present disclosure are not limited by the signal type and signal content of the original audio signal.

The compensation processing refers to a process of compensating (e.g., compensating the volume value of the audio signal) and/or adjusting (e.g., decreasing the volume of the audio signal that obviously exceeds the maximum volume range) the original audio signal.

On this basis, in the present application, through the Bluetooth headset and its corresponding configuration as provided, it is possible to perform good personalized audio compensation according to the monaural hearing loss curve based on the hearing losses of different persons through an audio compensation method for a Bluetooth headset in a simple and convenient manner, thereby improving the auditory experience of the user, especially allowing the user to have good call experience in personal calls.

Although in FIG. 5, the processor and the memory are presented as separate modules, those skilled in the art will appreciate that the above device modules can be implemented as separate hardware devices or can be integrated into one or more hardware devices. As long as the principles described in the present disclosure can be implemented, the specific implementation methods of different hardware devices should not be used as factors to limit the scope of protection of the present disclosure.

It should be understood that the processors in the earphone components in the Bluetooth headset can, for example, perform the method as described above and have functions as described above, which will not be described in detail here.

According to another aspect of the present disclosure, further provided is one or more non-volatile computer-readable storage media having computer-readable instructions stored thereon, and when the instructions are executed by a Bluetooth headset, the method described above can be performed.

The program portion of the technology can be considered as a “product” or “artifact” existing in the form of executable code and/or associated data, which is engaged or implemented through a computer-readable medium. A tangible, permanent storage medium can include the memory or storage used in any computer, processor, or similar device or related module. For example, various semiconductor memories, tape drives, disk drives, or any similar devices capable of providing storage functions for software.

All of the software or portions thereof can from time to time communicate over a network, such as the Internet or other communications networks. Such communication can load software from one computer device or processor to another. For example: it is loaded from one server or host computer of the target tracking device to a hardware platform of one computer environment, or another computer environment where the system is implemented, or a system of similar functionality related to providing information required for audio compensation. Therefore, another medium capable of transferring software elements can also be used as a physical connection between local devices, such as light wave, radio wave, electromagnetic wave, or the like, which are propagated through electric cables, optical cables, air, or the like. The physical medium used to carry waves, such as cables, wireless links, optical cables and the like devices, can also be considered a medium for carrying the software. As used herein, unless restricted to tangible “storage” media, other terms referring to computer or machine “readable media” refer to media that participate in the process of a processor executing any instructions.

The present application uses specific words to describe embodiments of the present application. For example, “first/second embodiment”, “an embodiment”, and/or “some embodiments” means a feature, structure, or characteristic associated with at least one embodiment of the present application. Accordingly, it should be emphasized and noted that “an embodiment” or “one embodiment” or “an alternative embodiment” referred to two or more times in different places in this specification does not necessarily refer to the same embodiment. In addition, certain features, structures, or characteristics of one or more embodiments of the present application can be combined as appropriate.

In addition, it can be understood by those skilled in the art that aspects of the present application can be illustrated and described by a number of patentable categories or circumstances, including any new and useful process, machine, product, or combination of substances, or any new and useful improvement thereof. Accordingly, aspects of the present application can be performed entirely by hardware, can be performed entirely by software (including firmware, resident software, microcode, or the like), or can be performed by a combination of hardware and software. All of the above hardware or software can be referred to as “data blocks”, “modules”, “engines”, “units”, “components” or “systems”. Additionally, aspects of the present application can be manifested as a computer product disposed in one or more computer-readable media, the product including computer-readable program code.

Unless otherwise defined, all terms used herein, including technical and scientific terms, have the same meaning as commonly understood by those of ordinary skill in the art to which the present disclosure belongs. It should also be understood that terms such as those defined in common dictionaries should be construed as having a meaning consistent with their meaning in the context of the relevant technology and should not be construed with idealized or extremely formalized meanings unless expressly defined as such herein.

The foregoing is a description of the present disclosure and should not be considered a limitation thereof. Although several exemplary embodiments of the present disclosure are described, it will be readily understood by those skilled in the art that many modifications can be made to the exemplary embodiments without departing from the novel teachings and advantages of the present disclosure. Accordingly, all such modifications are intended to be encompassed within the scope of the present disclosure as defined by the claims. It should be understood that the foregoing is a description of the present disclosure and should not be considered to be limited to the particular embodiments as disclosed, and that modifications to the disclosed embodiments, as well as other embodiments, are intended to be included within the scope of the appended claims. The present invention is defined by the claims and equivalents thereof.

What is claimed is:

1. An audio compensation method for a Bluetooth headset, wherein the Bluetooth headset comprises a pair of earphone components, the method comprising:
acquiring a monaural hearing loss curve corresponding to each ear of a user; wherein the monaural hearing loss curve corresponding to each ear of the user is generated based on a monaural hearing loss test of a corresponding ear of the user;
acquiring an original audio signal of the Bluetooth headset at a first time; and
compensating the original audio signal of the Bluetooth headset at the first time based on the monaural hearing loss curve corresponding to each ear of the user to generate a compensated audio signal.

2. The method of claim 1, wherein a process of generating the monaural hearing loss curve of each ear of the user based on the monaural hearing loss test of the corresponding ear of the user comprises:
for each ear of the user:
detecting a hearing level of the ear at a plurality of preset frequency points to obtain a maximum inaudible volume of the ear at each preset frequency point;
determining a hearing loss amount of the ear at each preset frequency point based on the maximum inaudible volume of the ear at each preset frequency point; and
determining the monaural hearing loss curve based on the hearing loss amount of the ear at each preset frequency point.

3. The method of claim 2, wherein detecting the hearing level of the ear at the plurality of preset frequency points to obtain the maximum inaudible volume of the ear at each preset frequency point comprises:
at each preset frequency point:
playing a preset audio signal corresponding to the preset frequency point to the user through a corresponding earphone component, wherein a volume of the preset audio signal decreases from a preset maximum volume to a preset minimum volume according to a preset rule;
obtaining hearing level feedback from the user; and
determining the maximum inaudible volume of the ear at the preset frequency point based on the hearing level feedback.

4. The method of claim 3, wherein the volume of the preset audio signal decreases from the preset maximum volume to the preset minimum volume by a preset volume interval value.

5. The method of claim 3, wherein obtaining the hearing level feedback from the user, and determining the maximum inaudible volume of the ear at the preset frequency point based on the hearing level feedback comprises:
not recording a current volume of the preset audio signal under a condition of obtaining a first hearing level feedback from the user;
recording the current volume of the preset audio signal under a condition of obtaining a second hearing level feedback from the user; and
determining the current volume as the maximum inaudible volume at the preset frequency point;
wherein the first hearing level feedback is different from the second hearing level feedback.

6. The method of claim 5, wherein the hearing level feedback is gesture feedback, and the Bluetooth headset further comprises a human-computer interaction part, wherein obtaining the hearing level feedback from the user comprises obtaining the gesture feedback from the user via the human-computer interaction part.

7. The method of claim 2, wherein determining the hearing loss amount of the ear at each preset frequency point based on the maximum inaudible volume of the ear at each preset frequency point comprises: determining the maximum inaudible volume at the preset frequency point as the hearing loss amount at the preset frequency point.

8. The method of claim 2, wherein before detecting the hearing level of the ear at the plurality of preset frequency points to obtain the maximum inaudible volume of the ear at each preset frequency point, the method further comprises: performing a hearing loss test preprocessing operation.

9. The method of claim 8, wherein the hearing loss test preprocessing operation comprises:
receiving personal information of users; and
determining the preset frequency point in the hearing loss test based on the personal information;
wherein the personal information comprises at least one of user's age, user's gender or user's hearing level information.

10. The method of claim 8, wherein the hearing loss test preprocessing operation comprises at least one of noise detection or wearing detection.

11. The method of claim 1, wherein compensating the original audio signal of the Bluetooth headset at the first time based on the monaural hearing loss curve corresponding to each ear of the user to generate the compensated audio signal comprises:
for each earphone component of the Bluetooth headset:
determining the monaural hearing loss curve of the corresponding ear of the user corresponding to the earphone component;
acquiring the original audio signal of the earphone component at the first time and a preset threshold volume corresponding to the earphone component; and
compensating the original audio signal based on the monaural hearing loss curve and the preset threshold volume to generate the compensated audio signal.

12. The method of claim 11, wherein compensating the original audio signal based on the monaural hearing loss curve and the preset threshold volume to generate the compensated audio signal further comprises:
determining a frequency point corresponding to the original audio signal;
determining a hearing loss amount corresponding to the frequency point on the monaural hearing loss curve;
determining an audio compensation parameter based on the hearing loss amount, the volume of the original audio signal, and the preset threshold volume; and
performing audio compensation processing on the original audio signal based on the audio compensation parameter to generate the compensated audio signal;
wherein a volume of the compensated audio signal is less than the preset threshold volume.

13. The method of claim 1, wherein the original audio signal at the first time is a original call audio signal at the first time.

14. One or more non-transitory computer-readable storage media having computer-readable instructions are stored thereon, and when the instructions are executed by a Bluetooth headset, cause the Bluetooth headset to perform the steps of:
acquiring a monaural hearing loss curve corresponding to each ear of a user; wherein the monaural hearing loss curve corresponding to each ear of the user is generated based on a monaural hearing loss test of a corresponding ear of the user;
acquiring an original audio signal of the Bluetooth headset at a first time; and
compensating the original audio signal of the Bluetooth headset at the first time based on the monaural hearing loss curve corresponding to each ear of the user to generate a compensated audio signal.

15. The one or more non-transitory computer-readable storage media of claim 14, wherein a process of generating the monaural hearing loss curve of each ear of the user based on the monaural hearing loss test of the corresponding ear of the user comprises:
for each ear of the user:
detecting a hearing level of the ear at a plurality of preset frequency points to obtain a maximum inaudible volume of the ear at each preset frequency point;
determining a hearing loss amount of the ear at each preset frequency point based on the maximum inaudible volume of the ear at each preset frequency point; and
determining the monaural hearing loss curve based on the hearing loss amount of the ear at each preset frequency point.

16. The one or more non-transitory computer-readable storage media of claim 15, wherein detecting the hearing level of the ear at the plurality of preset frequency points to obtain the maximum inaudible volume of the ear at each preset frequency point comprises:
at each preset frequency point:
playing a preset audio signal corresponding to the preset frequency point to the user through a corresponding earphone component, wherein a volume of the preset audio signal decreases from a preset maximum volume to a preset minimum volume according to a preset rule;
obtaining hearing level feedback from the user; and
determining the maximum inaudible volume of the ear at the preset frequency point based on the hearing level feedback.

17. The one or more non-transitory computer-readable storage media of claim 16, wherein the volume of the preset audio signal decreases from the preset maximum volume to the preset minimum volume by a preset volume interval value.

18. The one or more non-transitory computer-readable storage media of claim 16, wherein obtaining the hearing level feedback from the user, and determining the maximum inaudible volume of the ear at the preset frequency point based on the hearing level feedback comprises:
not recording a current volume of the preset audio signal under a condition of obtaining a first hearing level feedback from the user;
recording the current volume of the preset audio signal under a condition of obtaining a second hearing level feedback from the user; and
determining the current volume as the maximum inaudible volume at the preset frequency point;
wherein the first hearing level feedback is different from the second hearing level feedback.

19. The one or more non-transitory computer-readable storage media of claim 18, wherein the hearing level feedback is gesture feedback, and the Bluetooth headset further comprises a human-computer interaction part, wherein obtaining the hearing level feedback from the user comprises obtaining the gesture feedback from the user via the human-computer interaction part.

20. A Bluetooth headset, comprising a pair of earphone components, wherein each earphone component comprises a processor and a memory,
for each earphone component:
the memory is configured to store a monaural hearing loss curve of a corresponding ear of a user corresponding to the earphone component, wherein the monaural hearing loss curve of the corresponding ear of the user is generated based on a monaural hearing loss test of corresponding ear of the user; and
the processor is configured to:
acquire the monaural hearing loss curve from the processor;
acquire an original audio signal of the earphone component at a first time; and
compensate the original audio signal at the first time based on the monaural hearing loss curve to generate a compensated audio signal.
